(19) United States
(12) Patent Application Publication
(10) Pub. No.: US 2021/0114399 A1
(43) Pub. Date: Apr. 22, 2021

(54) INDEPENDENTLY POSITIONABLE TAB SYSTEM

(71) Applicant: Smead Manufacturing Company, Hastings, MN (US)

(72) Inventors: Marvin HALFEN, Hastings, MN (US); Scott WIEGREFE, Apple Valley, MN (US)

(21) Appl. No.: 17/067,011

(22) Filed: Oct. 9, 2020

Related U.S. Application Data
(60) Provisional application No. 62/915,738, filed on Oct. 16, 2019.

(51) Int. Cl. B42F 21/10; B42F 15/00

(52) U.S. Cl. CPC B42F 21/10; B42F 15/0035

(57) ABSTRACT

An independently positional tab for use with a folder, and a method of making the same is disclosed. The integral 2-D (flat) or 3-D tab is formed of two planar elements joined and folded along a central line. Portions of the inner surface of the tab have adhesive for affixation to a folder or document. Additionally, the tab may have lifting holes for removing the folder by pulling on the tab.

### CROSS REFERENCE TO RELATED APPLICATION

The present application herby incorporates by reference in its entirety, U.S. Pat. No. 8,550,330 entitled INTEGRATED TAB HANGING FILE SYSTEM issued on Oct. 8, 2013 and Provisional Application Ser. No. 62/915,738 of same title and inventor filed 16 Oct. 2019.

### FIELD OF THE INVENTION

The present invention is directed to a system for marking the edges of documents or folders or file folder-like products, and more particularly hanging folders with tabs.

### BACKGROUND

File folders, hanging file folders, and other paper storage systems are of great utility in an office setting. The most common storage system, the common manila folder, for example, is widespread and relatively inexpensive, and has convenient tabs suitable for writing. For hanging folders however, the typical system for marking the top edge is to use a known insert product which carries the label-indicia. In the days when typewriters were easily available, one would type the indicia on an insert, put it into a carrier, and install it on hanging folders in notches provided. With the disappearance of typewriters, the common solution is to handwrite these index tabs. Still the process of making an insert and putting it in a carrier and attaching the carrier is cumbersome.

In addition, most known systems have fixed locations for their tab. A few have sliding tab systems but they require a lot of structure (rails, clip over tabs, etc.). A user might want a unique tab location.

A solution needs to be found to provide a simple way to mark a simple tab system which is strong enough to stay vertical (or other angle) after long-term usage, retain the writing on the tab, be infinitely positionable, and be easily removed from a file drawer. Such tabbing system can also be used on single sheets such as documents to provide an easy way to mark/annotate them.

There are other issues relevant to the solution of the present invention and they are detailed below.

### BRIEF SUMMARY

The invention includes an independent tab unit (though it may be part of a sheet or roll of detachable tabs), in which one embodiment is formed of two planar elements folded down a center line. The planar element includes an adhesive portion at their distal ends (or may be entirely adhesive coated on their inside opposing surfaces). The adhesive surfaces are then applied to a document edge and when pressed together form a tab which can be located anywhere along the edge and at any height/depth into the document/folder within the height of the planar element. The outside surfaces (one or both) may optionally be coated with a material which allows for erasing of any indicia/writing thereon. An example of such a coating would be a plastic film or a lacquer which retains ink but which will not impregnate the surface.

An alternate embodiment may have two planar elements but of unequal length. This provides double thickness to the tab but only one adhesive anchoring point.

An alternate embodiment includes finger pull hole(s) on the lateral ends of the exposed tab portion. The opening, in the form of spaced apart apertures, provides the ability of the user to withdraw/lift the document/file from a filing cabinet without reaching deeper into the file itself. The tab therefore provides two functions, of a tab and a handle.

A further alternative is a tab which functions only as a handle/finger puller. One or more of these can be attached preferably at the distal ends of the folder and provide two finger hold tabs which are used for withdrawing the file folder.

### BRIEF DESCRIPTION OF THE DRAWINGS

FIG. 1 is a planar bottom view of two tabs attached end to end.

FIGS. 2A and 2B are perspective views of a tab like one shown in FIG. 1 affixed to a file folder. Here the affixation is by adhesive even though the folder is a hanging type with notches.

FIG. 3A is a top plan view of a tab folded flat.

FIG. 3B is a side sectional view showing a tab cross section of layers of laminate, adhesive, and matte base material.

FIG. 4 is a top planar view of a tab with multiple score lines to provide a 3-D shape with a top section.

FIG. 5 is a plan view of the embodiment in FIG. 4 with the tab in an unfolded state but using only two of the many score lines.

FIGS. 6 and 7 are top plan views of an alternate embodiment where one planar element of the tab is shorter than the other and only one adheres to the folder.

FIG. 8 is a full sheet of tabs shown in FIG. 7.

FIG. 9 is an alternative embodiment tab shown in top plan view.

FIG. 10 is a full sheet of tabs shown in FIG. 9.

FIG. 11 is a singulated tab of a second embodiment shown in a top plan view.

FIG. 12 is a sheet of separable tabs of FIG. 11.

FIG. 13 is a view like FIG. 12 except with lifting holes.

FIG. 14 is an embodiment with larger trapezoidal finger holes.

FIG. 15 is a separate pull tab with hole.

FIG. 16 is a folder with a writable tab and a pair of pull tabs.

FIG. 17 is a view like FIG. 16 showing a writable tab with lifting holes 50.

### DETAILED DESCRIPTION OF THE INVENTION

The present invention is directed to a separate tab system for a hanging folder, folder, or simply the edge of a document or other object. The tabs may be 2 or 3 dimensional. The term hanging folder is intended to encompass a range of other office requisites, such as binders, folios, clip boards, pockets, documents, simple folders, and any objects or similar items.

For the sake of brevity, the embodiments in the figures will be discussed simultaneously and the same reference numerals will be used whenever the elements are the same or similar.

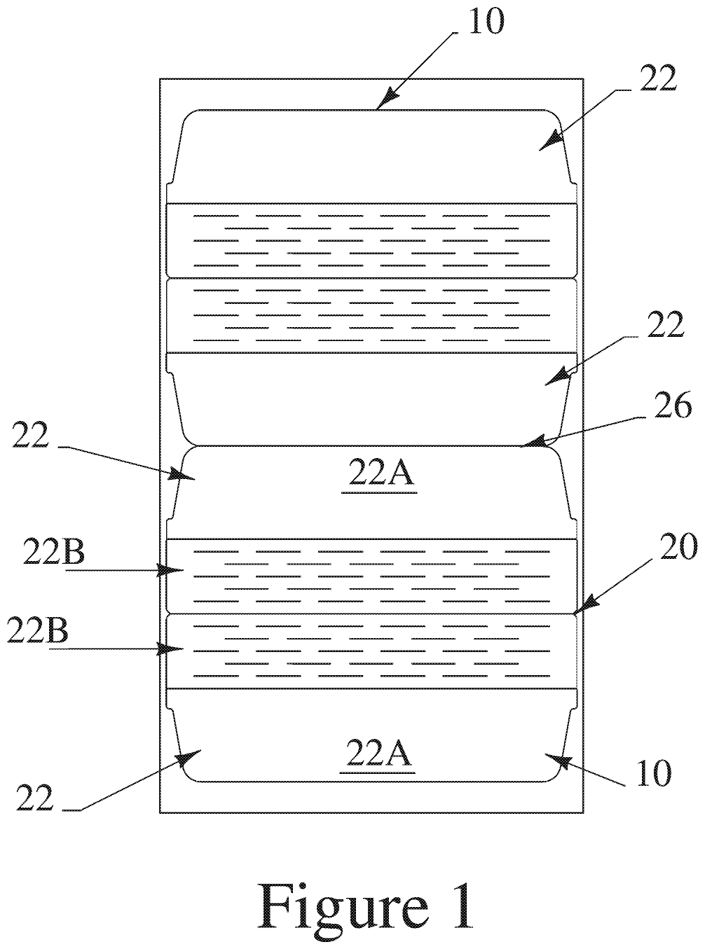

FIG. 1 is a partial planar bottom view of two complete tabs 10 (and portions of incomplete tabs) attached end to end along a separation line 20. Each tab is formed of two generally planar elements or portions 22 which have upper and lower portions 22A and 22B, with the elements folded along a fold line 26. The entire inner surface of elements 22 may be covered with adhesive or only the lower portion 22B. The adhesive may be releasable such as used on Post-It® notes or permanent with a protective tape/film which must be removed. It may also be an adhesive applied just prior to installation. The outside surfaces (one or both) may optionally be coated with a material which allows for erasing of any indicia/writing thereon. An example of such a coating would be a plastic film or a lacquer which retains ink but which will not impregnate the surface and which may be wiped off or removed with solvent.

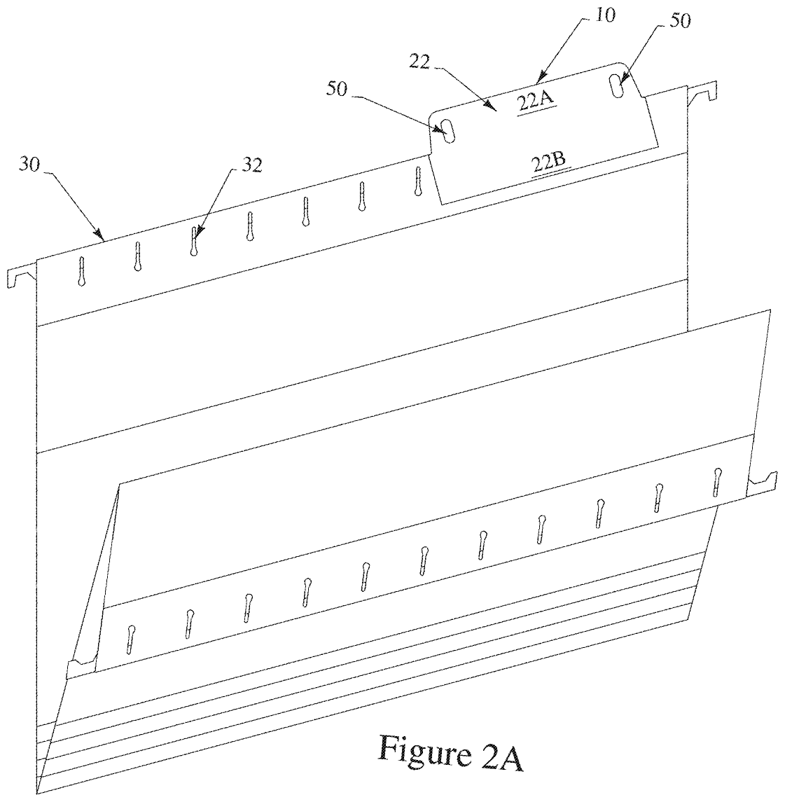

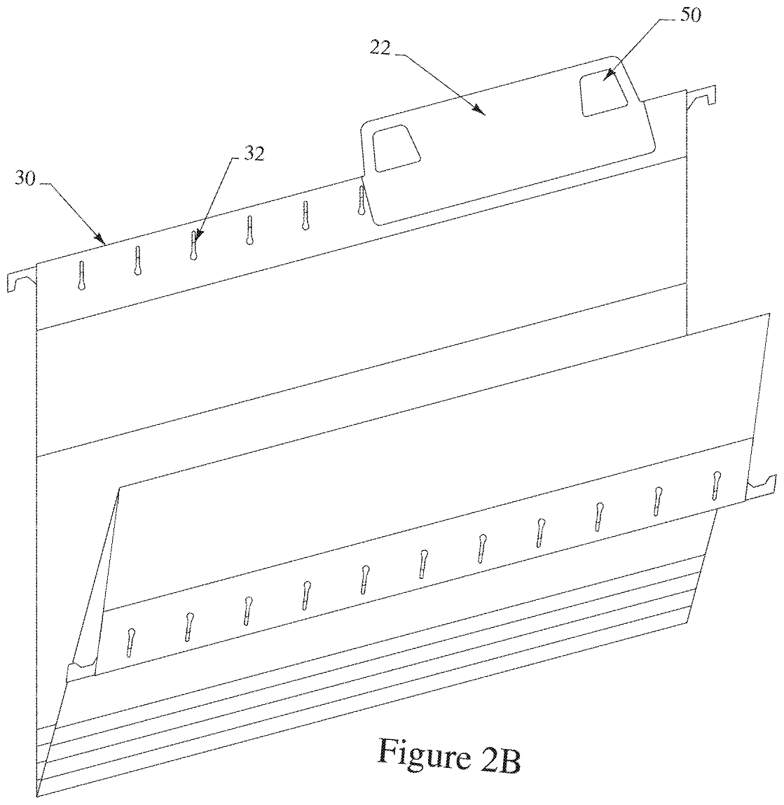

FIGS. 2A and 2B are perspective views of a tab like one shown in FIG. 1 affixed to a file folder 30. Note that the file folder shown is not one with notches/slots 32 for prior art tabs. The present embodiment may use such notches if appropriately die cut, but the adhesive removes the need for notch use. The tabs in this disclosure can be positioned anywhere along the folder/document without regard to such slots so it is infinitely positionable. FIG. 2B has larger finger holes in a trapezoidal shape.

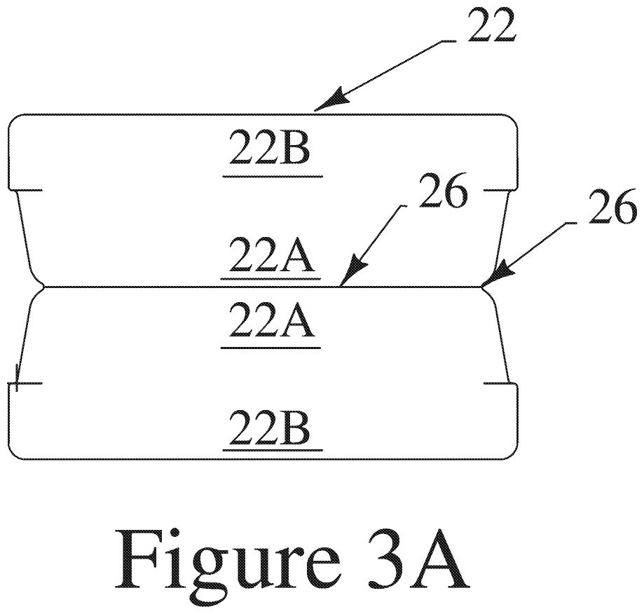

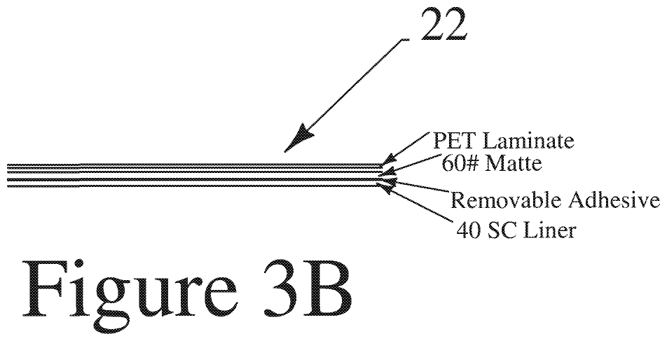

FIG. 3A is a top plan view of a tab folded flat.

FIG. 3B is a side sectional view showing a tab cross section of layers of laminate, adhesive, and matte base material with an optional erasable outer surface. In the preferred embodiment, the base layer is a fibrous or other material with a transparent laminate capable of receiving writing for imprinting. Some portions have an adhesive layer on the other face of the base layer. The layers may include PET laminate as an erasable surface, 60 pounds of matte material, and an adhesive layer, which may be of a reusable/removable type and a 40 SC line material.

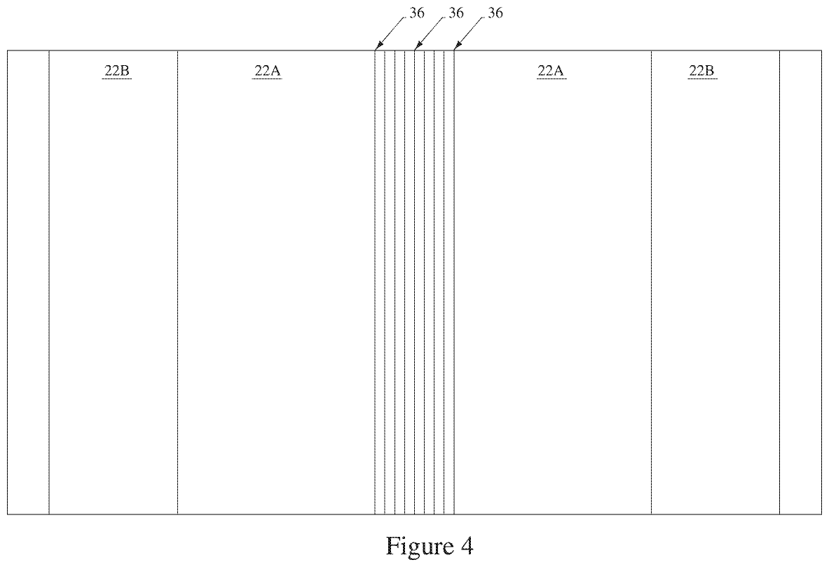

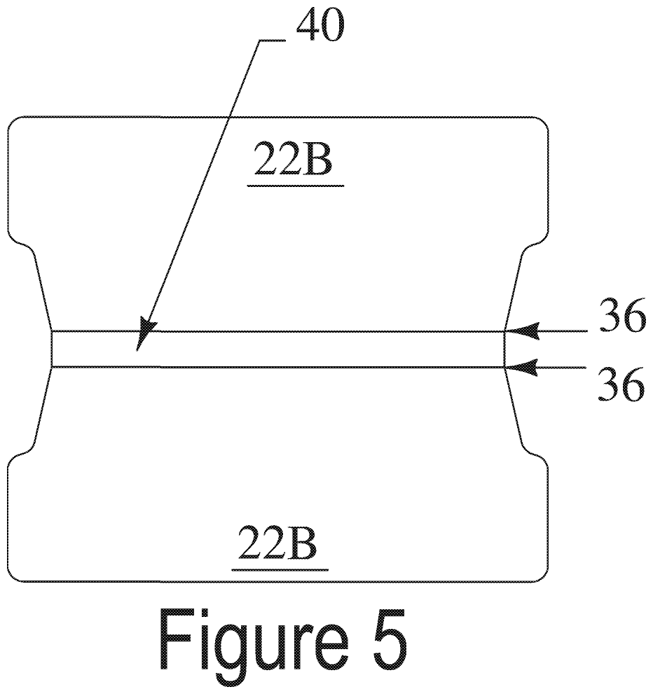

FIG. 4 is a top planar view of a tab that has optional multiple score lines 36 to provide a 3-D shape with a top section. Any two score lines can be selected to form the three-sided tab shape with a top portion 40 shown in FIG. 5. The affixation of the elements 22B will determine at what angle top portion 40 will be fixed at. A single score line may be used to provide a flat tab.

FIG. 5 is a plan view of the embodiment in FIG. 4 with the tab in an unfolded state but using only two of the many score lines.

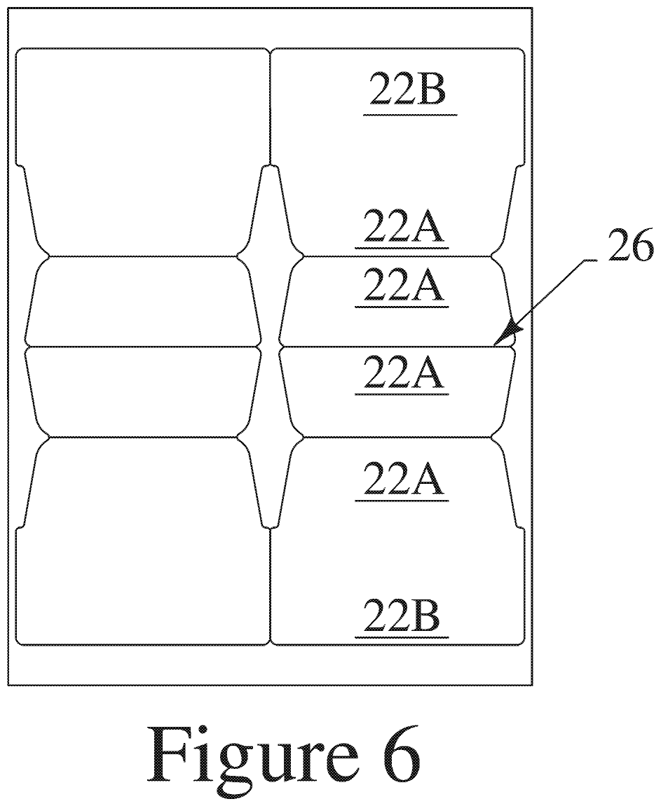

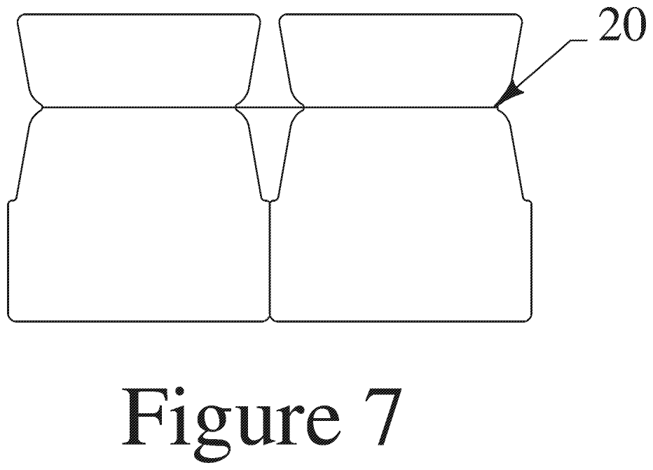

FIGS. 6 and 7 are top plan views of an alternate embodiment where one planar element of the tab is shorter than the other and only one adheres to the folder. In this case one side of the tab only includes an upper part 22A. The tab will not adhere as strongly but it may be sufficient in many cases. The tab provides a solution to folders where the minimum area is to be occluded by the tab.

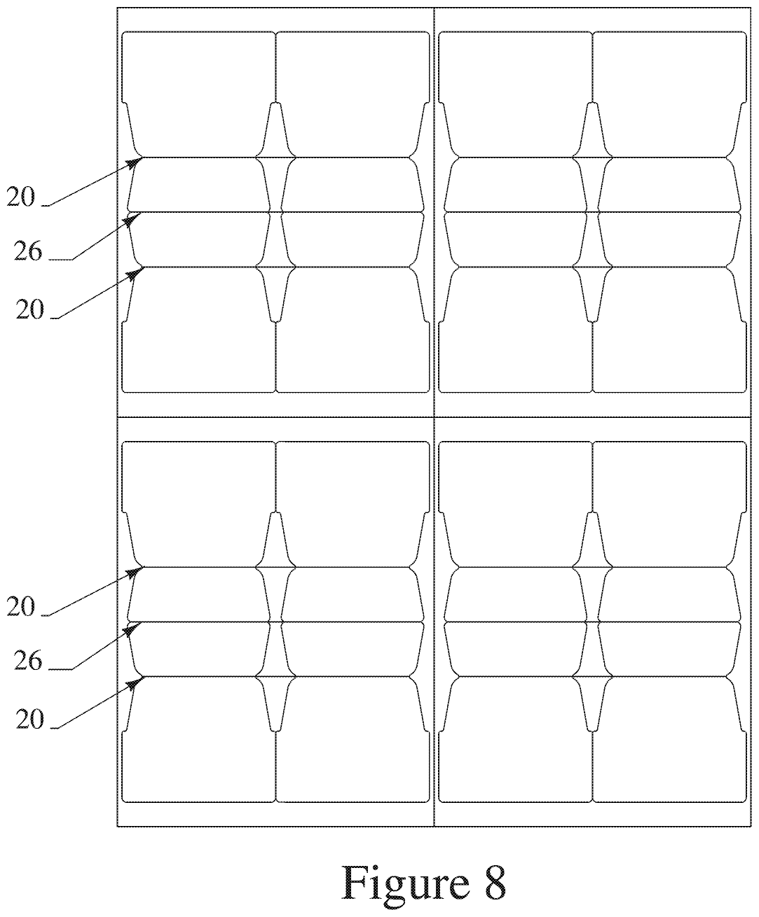

FIG. 8 is a full sheet of tabs shown in FIG. 7.

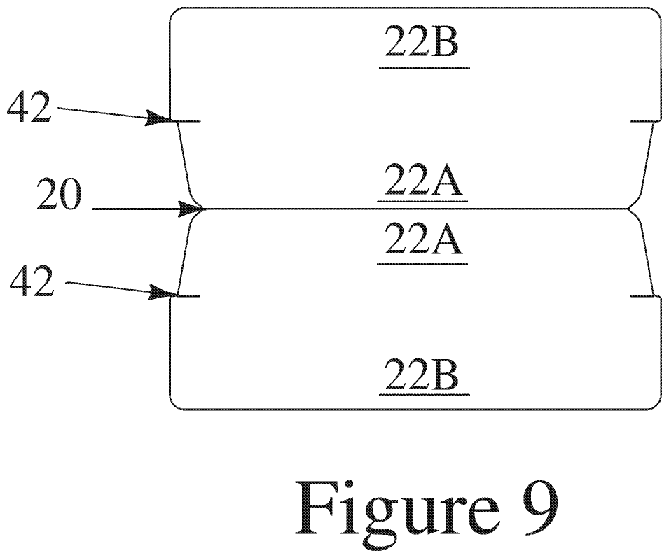

FIG. 9 is an alternative embodiment tab shown in top plan view with an inward notch 42 in the side wall between the top and bottom edges, preferably the midpoint between portions 22A/B to allow for greater flexure of the top and bottom portions. The notch can be a lateral cut in the sidewall extending less than 5 or 10% of the lateral distance across the tab. It may be on one or both sides.

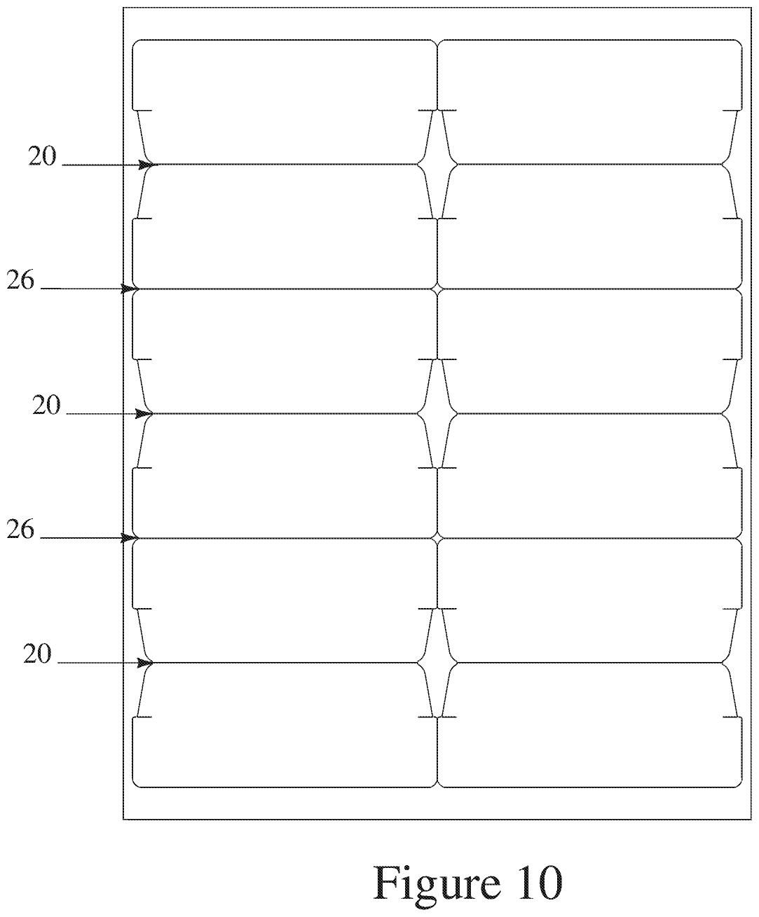

FIG. 10 is a full sheet of tabs shown in FIG. 9.

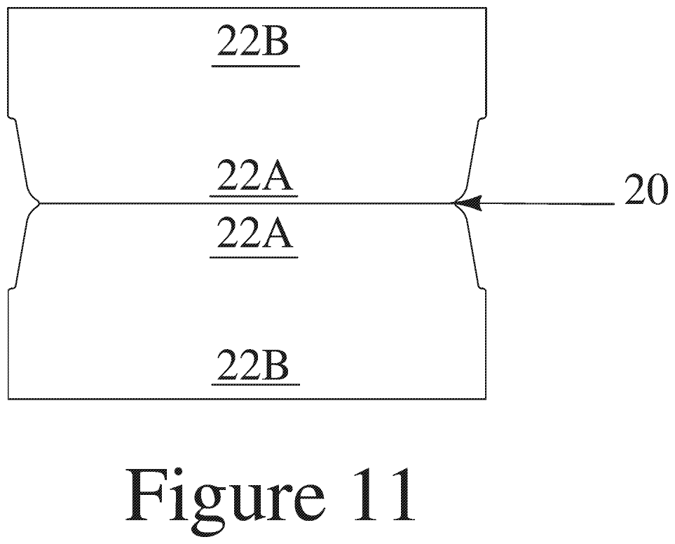

FIG. 11 is a singulated tab of a second embodiment shown in a top plan view.

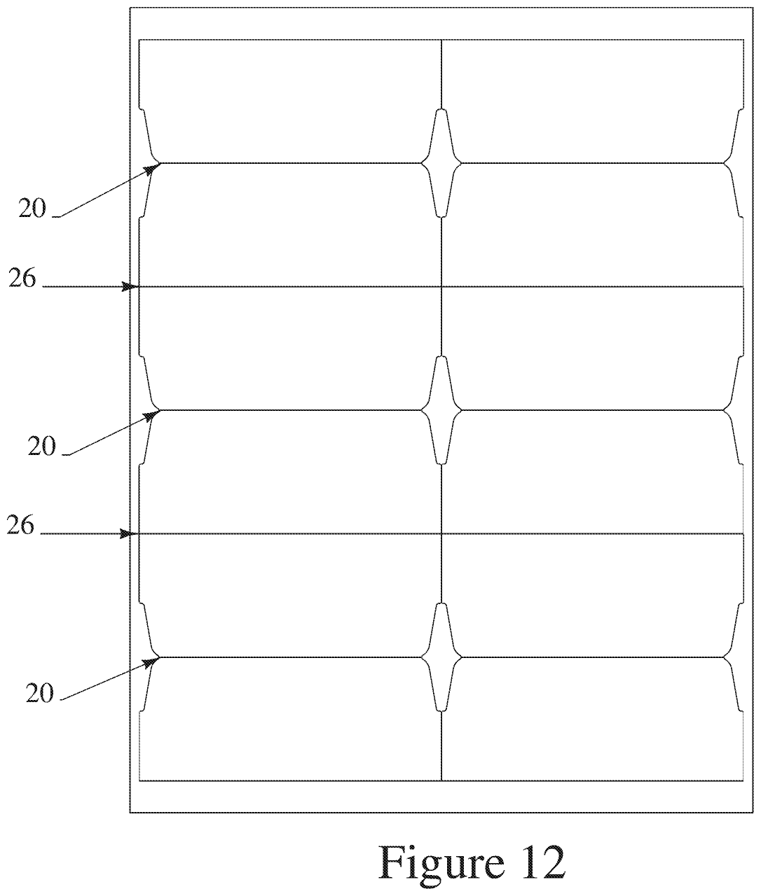

FIG. 12 is a sheet of separable tabs of FIG. 11.

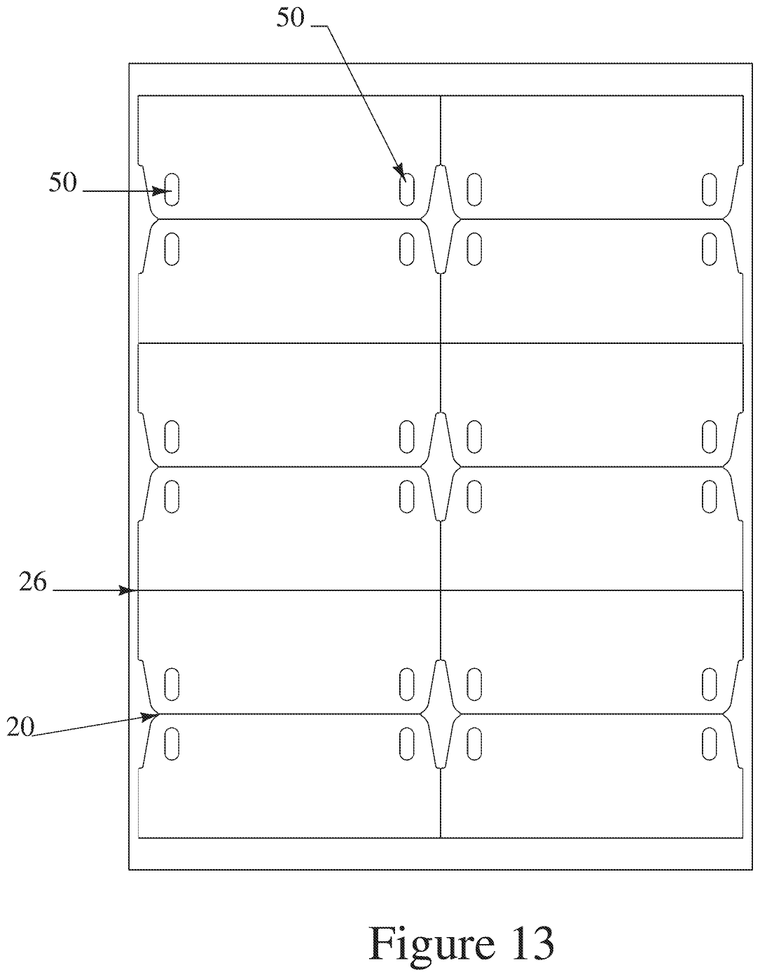

FIG. 13 is a view like FIG. 12 except with lifting holes 50 also shown in FIG. 2. Small holes 50 may be used with a wire puller tool having hooks, such as Smead® Copy Claw® tool U.S. Pat. No. D380495, or any pointed device like a pen which will engage the holes. The holes may have a rounded interior upper edge as shown to provide strength against tearing.

The lifting holes may be large enough to receive a finger such as shown in FIGS. 2B, 14, 15, and 16, or small enough for use with a lifting tool like the Smead® Copy Claw® tool U.S. Pat. No. D380495. Thus, a user may withdraw a folder/document from a file cabinet by engaging holes 50 and pulling upwardly, without the need to insert one's hand into the file cabinet to grasp the body of the folder.

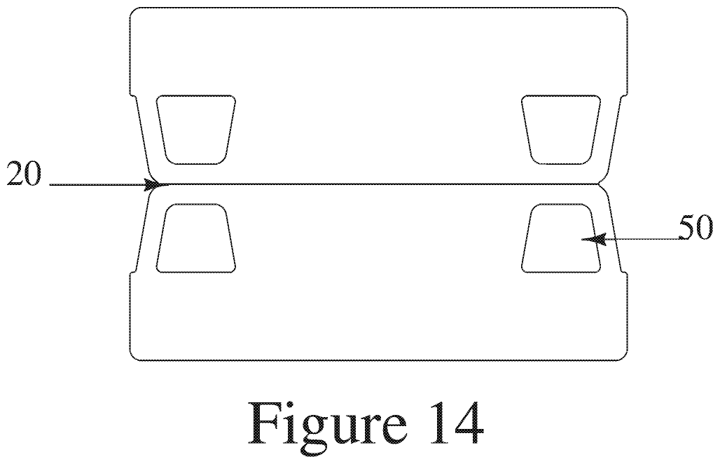

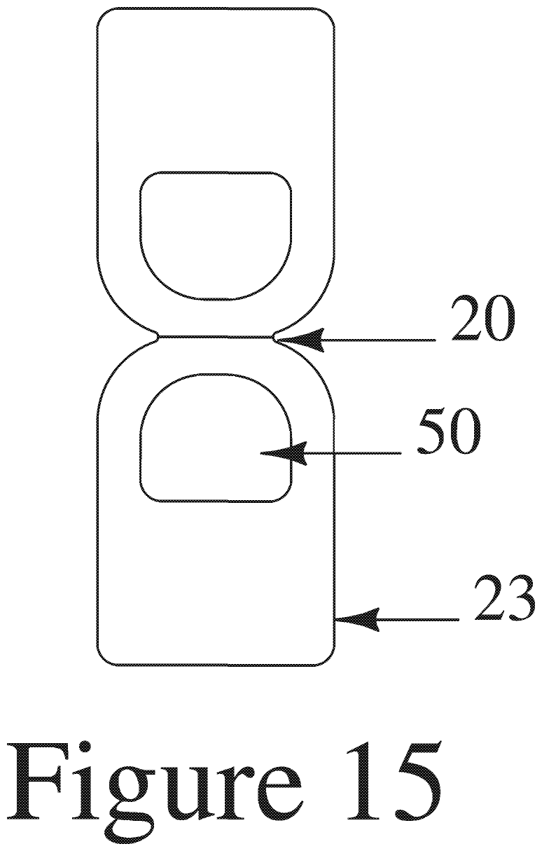

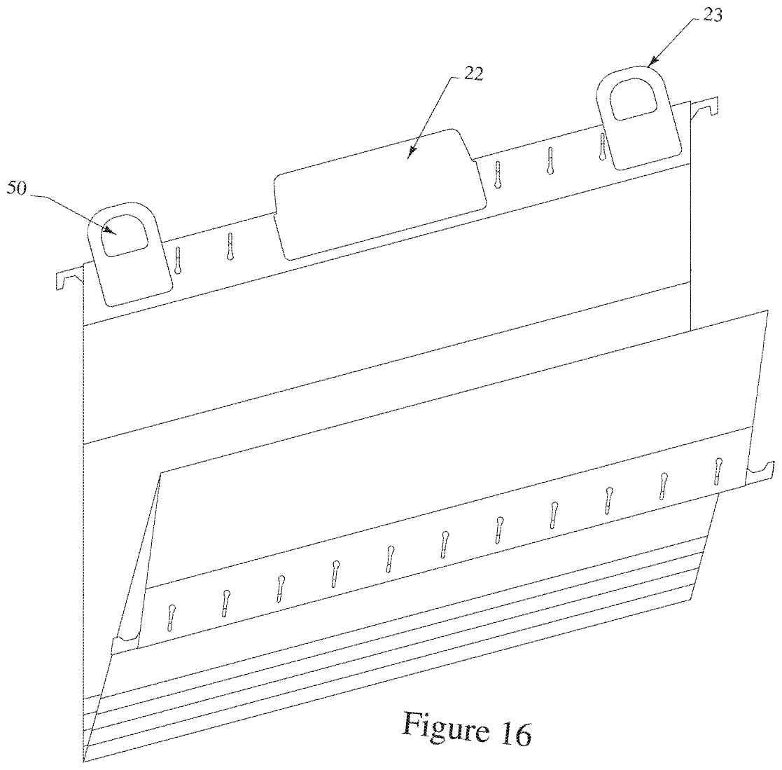

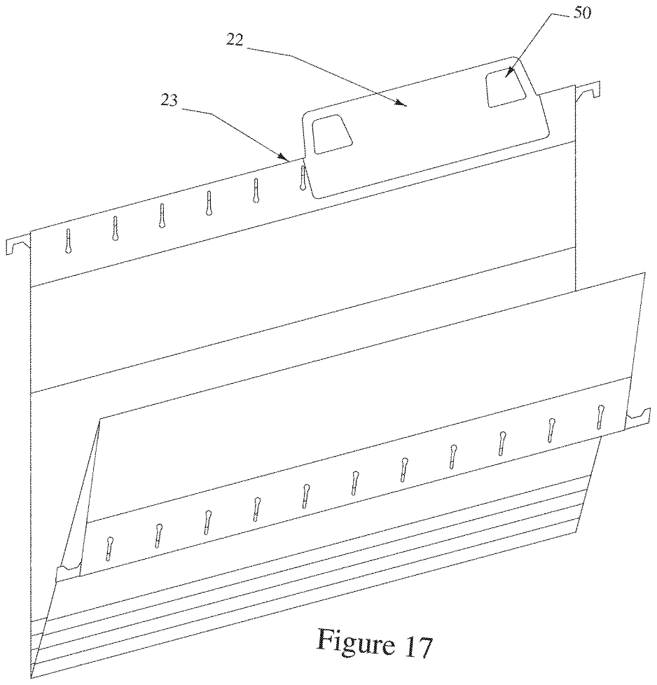

FIGS. 15 and 16 illustrate addition pull/puller tabs 23 which may only have finger holds/hooks and no writing surface. This attachable finger lifter tabs could likewise be placed anywhere, especially at the distal end (opposite where the other tab is located) of the folder/document for greatest leverage. The preferred location of the tabs is on either side of the lateral midpoint of the folder's top edge. In this case, the user can grab one or more lifting tabs, or use one lifting tab and one tab as shown in FIG. 14 to provide a vertical lifting force without torque.

Also disclosed is a method of making an infinitely adjustable tab by cutting a form from a planar web, the form having a central lateral fold line and elements on either side of the fold line. At least a portion of the inner surfaces of the elements includes an adhesive. Then, affixing the adhesive.

The description of the invention including its applications and advantages as set forth herein is illustrative and is not intended to limit the scope of the invention, which is set forth in the claims. Variations and modifications of the embodiments disclosed herein are possible and practical alternatives to and equivalents of the various elements of the embodiments which would be understood to those of ordinary skill in the art upon study of this patent document. These and other variations and modifications of the embodiments disclosed herein may be made without departing from the scope and spirit of the invention.

1. An infinitely positionable tab for a document or folder, comprising:
first and second two planar elements folded down a center line;
at least one of said planar element including an adhesive portion at its distal end said adhesive surfaces are then applied to a document edge and when pressed together to form a tab which can be located anywhere along the document edge and at any height/depth into the document/folder within the height of the planar element.

2. The tab of claim 1 further including lifting apertures in the tab planar elements.

3. The tab of claim 1 wherein the two planar elements are of unequal length.

4. The tab of claim 1 wherein one of the two planar elements is shorter than the other.

5. The tab of claim 1 wherein two planar elements include side edges and wherein at least one of the side edges includes a lateral notch extending into the tab.

6. The tab according to claim 1 further including a second lifting tab having an aperture.

7. The tab according to claim 1 further including an aperture sized to be engaged for lifting the folder.

8. The tab of claim 7 wherein said aperture has an interior edge and at an upper edge the aperture is rounded.

9. An infinitely positionable pulling tab for a document or folder, comprising:
first and second two planar elements folded down a center line;
at least one of said planar element including an adhesive portion at its distal end said adhesive surfaces are then applied to a document edge;
at least one aperture through said planar elements to provide a lifting hole for withdrawing the folder; and when pressed together form a tab which can be located anywhere along the document edge and at any height/depth into the document/folder within the height of the planar element.

10. The tab of claim 9 further including a writing surface adjacent the lifting hole.

11. A method of making an infinitely adjustable tab for a file folder, comprising cutting a form from a planar web, the form having a central lateral fold line and elements on either side of the fold line; at least a portion of the inner surfaces of the elements including an adhesive; affixing the adhesive coated surfaces on both faces of a folder and adhering them thereto.

12. The method of claim 11 further including:
forming an aperture in a tab on either side of the fold line to create a lifting aperture.

13. The method of claim 11 further including:
forming a second tab distant from and spaced apart from the tab, said tab and second tab including a lifting aperture.

14. The method of claim 11 wherein the folder includes a midpoint and further including locating said tab and second tab on the folder, where the tab and second tab are on either side of the midpoint.
